(19) United States
(12) Patent Application Publication
(10) Pub. No.: US 2009/0302548 A1
(43) Pub. Date: Dec. 10, 2009

(54) Sequentially-Deployable Lip Seal Systems

(75) Inventor: Thomas W. Ramsay, Waterloo (CA)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Ashbridge & Roseburgh Inc., Waterloo, ON (CA)

(21) Appl. No.: 12/092,597

(22) PCT Filed: Nov. 15, 2006
(86) PCT No.: PCT/IB06/04245

§ 371 Date: Sep. 18, 2008

Related U.S. Application Data
(60) Provisional application No. 60/736,927, filed on Nov. 15, 2005.
(60) Provisional application No. 60/803,101, filed on May 24, 2006.

(51) Int. Cl. F16J 15/32

(52) U.S. Cl. 277/558; 277/562

(57) ABSTRACT

Apparatus to enhance performance of sequentially-deployable lip seal assemblies. In certain embodiments, biasing members to ensure deployment of sequentially deployable lip seals include an o-ring mounted within a cartridge or housing of one or more yet-to-be-deployed lip seals, with the o-ring disposed immediately adjacent one of the lip seals. When a barrier member or deployment sleeve is interposed between the one or more yet-to-be-deployed lip seals and a shaft, such as a rotating and/or reciprocating shaft of a stuffing box, the o-ring biases the lip seal toward the outside diameter of the shaft. Upon movement of the barrier member or deployment sleeve to a position exposing the Hp seal to the shaft, the o-ring urges the lip seal into engagement with the outside diameter of the shaft. A pressurized fluid may be employed between the housing and the o-rings. Flush paths, multi-part housings, and baffle-type housings are also disclosed.

### REFERENCE TO RELATED APPLICATIONS

This application claims priority to, and is entitled to the benefit of, U.S. Provisional Patent Application Nos. 60/736,927, filed Nov. 15, 2005, entitled APPARATUS TO ENSURE DEPLOYMENT OF SEQUENTIALLY-DEPLOYABLE LIP SEALS, and 60/803,101, filed May 24, 2006, entitled SEQUENTIALLY DEPLOYABLE LIP SEAL SYSTEM HAVING BELLOWS-STYLE CARTRIDGE, for all subject matter commonly disclosed therein.

### FIELD OF THE DISCLOSURE

This disclosure relates generally to lip seals for rotating or reciprocating shafts and, more particularly, to replacement seal systems that provide sequentially-deployed lip seals which selectively engage moving elements, such as rotating and/or reciprocating shafts, through relative movement between a barrier member and the lip seal members, and to apparatus to assure deployment of the lip seals, as well as to replacement seal systems having housings to promote concentricity between the lip seal members and the moving elements and resist premature seal leakage.

### BACKGROUND

In operation, lip seals provided on rotating and/or reciprocating shafts of fluid-handling machinery have a limited useful life due to wear. At the end of the useful life, leakage will develop at the interface between the stationary lip seal and the rotating and/or reciprocating shaft. When leakage is observed, the operation of the fluid handling machine generally must be terminated and the sealing apparatus must be at least partially dismantled to replace the lip seal. Such dismantling and maintenance is time consuming and expensive. Additionally, there is the possibility that a significant cost in operating downtime may be suffered due to the replacement of the lip seal.

Sequentially-deployable lip seals, such as disclosed in U.S. patent application Ser. Nos. 10/312,020 and 10/387,730, which are incorporated herein by reference (to the extent those applications do not themselves incorporate by reference any other patents, publications or applications), are designed so that, upon detection of wear or leakage of a lip seal that has been in sealing engagement with a rotating and/or reciprocating shaft, a replacement lip seal, already loaded in a ready-to-deploy condition, is deployed. In order to deploy the replacement lip seal, a barrier member or release sleeve movable relative to the yet-to-be-deployed replacement lip seal moves from a first position between the lip seal and the shaft to a second position exposing the lip seal to the shaft. In this manner, fluid-handling machinery with rotating and/or reciprocating shafts may be used continuously without having to be dismantled for seal replacement. Replacement is only necessary upon exhaustion of the useful life of all lip seals in a given assembly or cartridge of a plurality of sequentially deployable lip seals.

Due to demand for greater seal longevity, the elastomeric material from which lip seals are made, such as Polytetrafluoroethylene (PTFE or Teflon®), or Gylon® available from Garlock, Inc. of Palmyra, N.Y., generally resists wear and leakage. Thus, it may be months or even years before a lip seal has worn or begins leaking to the extent that a substitute lip seal needs to be deployed. Where there is more than one substitute lip seal loaded in a ready-to-deploy condition, the length of time before deployment of the subsequent lip seals is progressively longer for each successive substitute lip seal. When stored for a long period of time in the loaded, ready-to-deploy condition, the substitute lip seal(s) may resist immediate deployment, even when the trigger mechanism for releasing the lip seal, such as the barrier member or release sleeve, is moved to a position permitting deployment of the lip seal. Cold temperatures may also slow or impede immediate deployment of the substitute lip seal.

When a substitute seal does not immediately deploy, it is found that operators of the fluid handling machinery desiring prompt lip seal deployment often proceed to attempt to trigger the release or deployment of yet another substitute lip seal, and continue attempting to deploy substitute lip seals successively until one of the lip seals deploys, or until all loaded lip seals are exposed by the barrier member or release sleeve for deployment. If more than one of the triggered lip seals ultimately deploy, there may be too much resistance to rotational and/or reciprocal movement of the shaft. Another drawback of prematurely deploying successive lip seals is that the longevity of the sequentially deployable lip seal assembly or cartridge is diminished, because each lip seal is not being utilized to its full potential.

While positive process pressure in real-world applications tends to enhance deployment and improve the integrity of the sealing engagement of lip seals with rotating and/or reciprocating shafts about which they are employed, there are often situations where there is little or no pressure acting on the lip seals and shafts in a stuffing box or in other applications. For example, pressures of as little as 5 psi, 0 psi, or even negative pressure or vacuum, are not uncommon. In these situations, there is little pressure to enhance the integrity of the sealing engagement. Under vacuum conditions, the integrity of the sealing engagement may even be degraded by the negative pressure.

It would therefore be desirable for a sequentially-deployable lip seal assembly to be provided with an apparatus or mechanism for ensuring prompt deployment of the loaded, yet-to-be-deployed, lip seals upon triggering the release or deployment of each such lip seal, regardless of process pressure conditions.

The service life of an assembly or cartridge of sequentially deployable lip seals is optimized when each of the lip seals is utilized to its full potential. The rotating or reciprocating shafts on which the lip seals are deployed experience shaft deflection and vibration which may cause premature seal leakage. These conditions lead to what is referred to in the art as “shaft run out.” While sequentially deployable lip seal cartridges are designed to tolerate a certain degree of shaft run out, the total indicated run out (or “TIR”) can be rather small, on the order of 0.005″, before seal leakage. Because users may have a tendency to initiate deployment of a next-successive lip seal upon initial detection of a leak, such premature seal leakage may result in a shorter than optimal assembly or cartridge service life.

Efforts have been made to minimize shaft deflection by providing supporting rings at first and second ends of the housing of an assembly or cartridge of sequentially deployable lip seals, as discussed in the Applicant's U.S. patent application Ser. No. 11/151,143. However, such supporting rings require extra parts, which in turn increases cost and labor involved in cartridge replacement. Application Ser. No. 11/151,143 is also incorporated herein by reference (to the extent it does not incorporate by reference any other patents, publications or applications).

### BRIEF DESCRIPTION OF THE SEVERAL VIEWS OF THE DRAWING

FIG. 1 is a perspective view, shown in cross-section, of a sequentially deployable lip seal assembly, with each of a plurality of sequentially deployable lip seals provided with an apparatus to ensure their deployment;

FIG. 2 is a perspective view, shown in cross-section, of the sequentially deployable lip seal assembly of FIG. 1, shown after deployment of one of the substitute lip seals;

FIG. 3 is an enlarged perspective view, shown in cross-section, of the sequentially deployable lip seal assembly of FIG. 1;

FIG. 4 is a front plan view of an apparatus for ensuring deployment of a lip seal;

FIG. 5 is a cross-sectional view, taken along lines 5-5 of FIG. 4;

FIG. 6 is a side plan view of a simulated shaft assembly including three cylindrical shaft sections of different diameters arranged in a contiguous fashion, largest to smallest, provided with a sequentially deployable lip seal assembly, wherein none of the lip seals are provided with apparatus to ensure their deployment;

FIG. 7 is a side plan view of the shaft assembly and sequentially deployable lip seal assembly provided in FIG. 6, shown after all the lip seals have been exposed for deployment along a second of the shaft sections, which shaft section simulates a rotating sleeve of a shaft assembly;

FIG. 8 is a side plan view of the shaft assembly and sequentially deployable lip seal assembly provided in FIG. 6, shown after all the lip seals have been exposed for deployment along a smallest of the shaft sections, which shaft section has a diameter smaller than an outside diameter of a shaft about which lip seals would normally be deployed;

FIG. 9 is a side plan view of a simulated shaft assembly including three cylindrical shaft sections of different diameters arranged in a contiguous fashion, largest to smallest, provided with a sequentially deployable lip seal assembly, wherein each of the lip seals are provided with apparatus of the present disclosure to ensure their deployment;

FIG. 10 is a side plan view of the shaft assembly and sequentially deployable lip seal assembly provided in FIG. 9, shown after all the lip seals have been exposed for deployment along a second of the shaft sections, which shaft section simulates a rotating sleeve of a shaft assembly;

FIG. 11 is a side plan view of the shaft assembly and sequentially deployable lip seal assembly provided in FIG. 9, shown after all the lip seals have been exposed for deployment along a smallest of the shaft sections, which shaft section has a diameter smaller than an outside diameter of a shaft about which lip seals would normally be deployed;

FIG. 12 is a side cross-section view, partially broken away, showing a sequentially deployable lip seal assembly during insertion of a barrier member or release sleeve to load the deployable lip seals and apparatus of the present disclosure to ensure their deployment;

FIG. 13 is a side cross-sectional view, partially broken away, similar to FIG. 12, but showing the barrier member or release sleeve inserted further into the sequentially deployable lip seal assembly;

FIG. 14 is a partial side cross-sectional view of a plurality of lip seals, apparatus of the present disclosure to ensure deployment of each of the lip seals, and cylindrical spacer elements;

FIG. 15 is a partial side cross-sectional view similar to FIG. 14, and showing a portion of a shaft and a barrier member or release sleeve inserted between the shaft and the plurality of lip seals;

FIG. 16 is a partial side cross-sectional view similar to FIG. 15, and showing two of the lip seals deployed against a surface of the shaft, and showing the barrier member or release sleeve interposed between the shaft and the remaining undeployed lip seal;

FIG. 17 is a partial side cross-sectional view of a plurality of lip seals, showing biasing members in the form of o-rings to ensure deployment of each of the lip seals, and a cavity between each of the o-rings and the housing to which a pressurized fluid is supplied via a fluid supply passage.

FIG. 18 is a partial side cross-sectional view similar to FIG. 17, and showing one of the lip seals which is biased toward the shaft deployed against the shaft, and showing the barrier member or release sleeve interposed between the shaft and the remaining undeployed lip seals;

FIG. 19 is a side cross-sectional view of a plurality of lip seals, showing biasing members in the form of o-rings to ensure deployment of each of the lip seals, and a cavity between each of the o-rings and the housing to which a pressurized fluid is supplied via a fluid supply passage, and a flush path to supply fluid to an area immediately adjacent the interface between the lip seals and the shaft;

FIG. 20 is a side cross-sectional view similar to FIG. 19, and showing one of the lip seals which is biased toward the shaft deployed against the shaft, and showing the barrier member or release sleeve interposed between the shaft and the remaining undeployed lip seals;

FIG. 21 is a cross-sectional view of a cylindrical cartridge of the present disclosure, in combination with a release sleeve and a shaft, with the release sleeve in a position prior to deployment of a plurality of annular lip seals of the cylindrical cartridge;

FIG. 22 is a cross-sectional view similar to FIG. 21, but showing the cylindrical cartridge in a fully retracted position, after deployment of all of the annular lip seals of the cylindrical cartridge;

FIG. 23 is a cross-sectional view of the cylindrical cartridge of FIG. 21, without the release sleeve and without a shaft disposed therein;

FIG. 24 is a partial cross-section, showing both the exterior and interior of a cylindrical cartridge of the present disclosure;

FIG. 25 is a plan view showing the exterior of a cylindrical cartridge of the present disclosure;

FIG. 26 is a cross-sectional view of a cylindrical cartridge of the present disclosure, prior to formation of annular grooves therein and prior to initial flexing of the annular lip seals;

FIG. 27 is a cross-sectional view similar to FIG. 26, after initial flexing of the annular lip seals;

FIG. 28 is a cross-sectional view similar to FIG. 27, after formation of annular grooves in the cylindrical cartridge;

FIG. 29 is a cross-sectional view similar to FIG. 28, showing the cartridge mounted to a gland having a shaft-receiving aperture;

FIG. 30 is a cross-sectional view of the cartridge and gland of FIG. 29, in combination with a release sleeve and a deployment rod for controlling sequential deployment of annular lip seals loaded against an exterior of the release sleeve;

FIG. 31 is a cross-sectional view of a cartridge and gland in combination with a release sleeve and a deployment rod for controlling sequential deployment of annular lip seals loaded against an exterior of the release sleeve, and with a shaft received in the cartridge and release sleeve, with a flush path ported through the gland and cartridge;

FIG. 32 is a cross-sectional view similar to FIG. 31, with directional arrows indicating the path of flush fluid;

FIG. 33 is a side view of the cartridge of FIG. 31, with the gland, release sleeve, and stuffing box shown in cross-section;

FIG. 34 is a side view, partially cut away, of a two-part cylindrical cartridge of the present disclosure;

FIG. 35 is a cross-sectional view of the two-part cylindrical cartridge of FIG. 34;

FIG. 36 is a top cross-sectional view of a first part of the two-part cylindrical cartridge of FIG. 34;

FIG. 37 is a top cross-sectional of a second part of the two-part cylindrical cartridge of FIG. 34;

FIG. 38 is a side exploded view of the two-part cylindrical cartridge of FIG. 34, with the first part and second part of the two-part cylindrical cartridge about to be engaged with one another, and with a portion of the first part of the two-part cylindrical cartridge cut away;

FIG. 39 is an exploded cross-sectional view of the two-part cylindrical cartridge of FIG. 34, with the first part and second part of the two-part cylindrical cartridge about to be engaged with one another;

FIG. 40 is a cross-sectional view of the two-part cylindrical cartridge of FIG. 34, prior to initial flexing of the annular lip seals;

FIG. 41 is a cross-sectional view of the two-part cylindrical cartridge of FIG. 34, after initial flexing of the annular lip seals;

FIG. 42 is an exploded side view of a two-part cylindrical cartridge similar to that shown in FIGS. 34-41, including first and second clamp-receiving grooves, with the first part and second part of the two-part cylindrical cartridge about to be engaged with one another;

FIG. 43 is an exploded side view of the two-part cylindrical cartridge of FIG. 42, with a portion of the first part and a portion of the second part of the two-part cylindrical cartridge cut away;

FIG. 44 is a side view of the two-part cylindrical cartridge of FIG. 42, with a portion of the first part and a portion of the second part of the two-part cylindrical cartridge cut away;

FIG. 45 is a side view of the two-part cylindrical cartridge of FIGS. 42-44;

FIG. 46 is a side view of the two-part cylindrical cartridge of FIGS. 42-45, with clamping rings received in the first and second clamp-receiving grooves;

FIG. 47 is a side view of the two-part cylindrical cartridge of FIG. 46, received in a gland;

FIG. 48 is an exploded cross-sectional view of a two-part cylindrical cartridge similar to FIG. 39, with the annular lip seals in a pre-flexed condition;

FIG. 49 is an exploded cross-sectional view of a two-part cylindrical cartridge and a pair of clamping rings, with the first part and second part of the two-part cartridge partially engaged with one another;

FIG. 50 is a cross-sectional side-view of the two-part cylindrical cartridge of FIGS. 48 and 49, with the pair of clamping rings received in the clamp-receiving grooves; and

FIG. 51 is a top plan view of a clamping ring.

### DETAILED DESCRIPTION OF THE PREFERRED EMBODIMENTS

### Apparatus for Ensuring Deployment of Lip Seals

An apparatus or device for ensuing deployment of axially-spaced, inwardly directed, sequentially deployable lip seals 10 may be a biasing member taking the form of an o-ring 12 having an integral mounting flange 14 projecting radially outward therefrom. The combination of the o-ring 12 and mounting flange 14 form an energizing device 15. It will be appreciated that, instead of being formed integrally with the o-ring 12, the radially extending mounting flange 14 could be formed separately and adhered to the o-ring 12, but it is believed that the most efficient way to manufacture the energizing device 15 is to form the o-ring 12 and radially extending mounting flange 14 as an integral part. For example, the energizing device 15 may be molded in a single cavity, two-part mold. The mold parts cooperate to define a toroidal opening for the molding of the o-ring 12, with a parting line bisecting the toroidal opening. Instead of providing the mold parts in such a fashion that avoids any flashing on the exterior of the o-ring 12, at least one of the mold parts has a radially-extending recess surrounding the semi-toroidal opening of the mold part. Thus, as the o-ring 12 is molded within the mold parts, the material of which the o-ring 12 is molded extrudes into the radially-extending recess, resulting in the radially extending mounting flange 14.

In an exemplary lip seal assembly 16, the integral mounting flange 14 of an energizing device 15 is secured between a cylindrical spacer element 18 and a lip seal 10. A plurality of the sequentially deployable lip seals 10, integral mounting flanges 14, and cylindrical spacer elements 18 are loaded into a sealing apparatus to form the lip seal assembly 16, such as from a rear end of a housing 20 of the lip seal assembly 16.

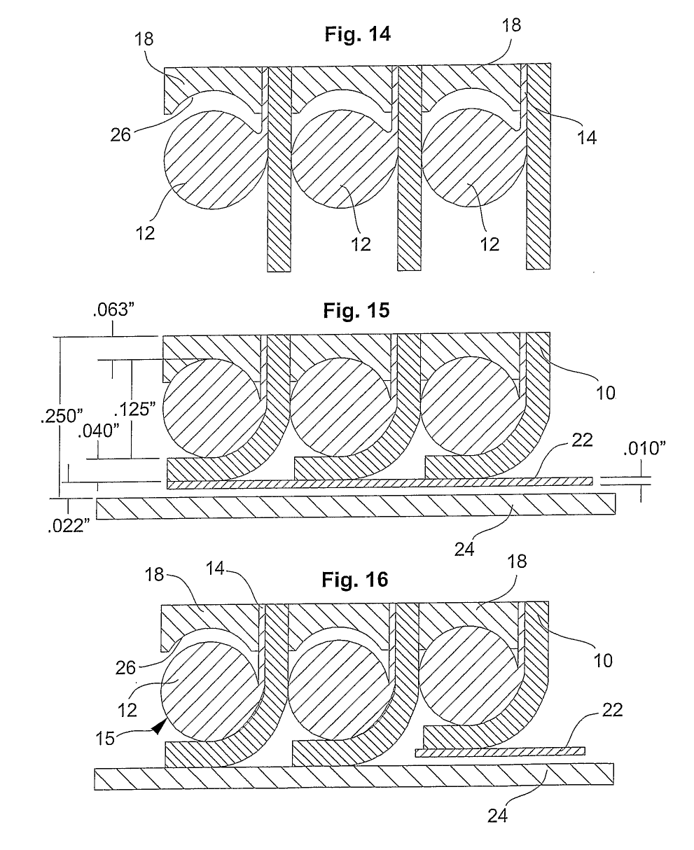

A barrier member or release sleeve 22 (sometimes referred to as a deployment sleeve) having an inner diameter greater than an outer diameter of a shaft 24 about which the lip seals 10 are to be deployed, and an outer diameter greater than an inner diameter of the lip seals 10, is inserted into place from one end of the housing 20 toward an opposite end of the housing 20. The lip seals 10 are thereby loaded against the outer diameter of the release sleeve 22. Each of the o-rings 12 of the energizing devices 15 has an inner diameter less than the combined outer diameter of the release sleeve 22 and twice the thickness of one of the annular lip seals 10 (and preferably, an inner diameter equal to an outer diameter of the shaft 24 about which the lip seal 10 is to be deployed), such that upon insertion of the release sleeve 22 (i.e. upon loading of the deployable lip seals), each o-ring 12 is stretched beyond its inner diameter, and therefore biases the inner diameter of the adjacently-mounted lip seal 10 in a direction toward the release sleeve 22, and thereby toward the shaft 24. As best shown in FIG. 14, each of the cylindrical spacer elements 18 may be provided with a recess or channel 26 along an interior thereof which is complementary to the curvature of an outer surface of the o-ring 12.

The combination of the lip seal assembly 16 and the barrier member or release sleeve 22 is installed about a shaft 24 of, for example, a fluid handing machine. The shaft 24 may rotate, reciprocate, or both. To deploy one of the plurality of lip seals 10, the barrier member or release sleeve 22 is actuated to move axially relative to the shaft 24 and the lip seals 10 until one of the lip seals 10 is exposed to the shaft 24. Promptly upon such exposure, the o-ring 12 of the energizing device 15 urges the exposed lip seal 10 into sealed engagement with the shaft 24. Such sealed engagement continues until the lip seal 10 wears sufficiently to cause leakage.

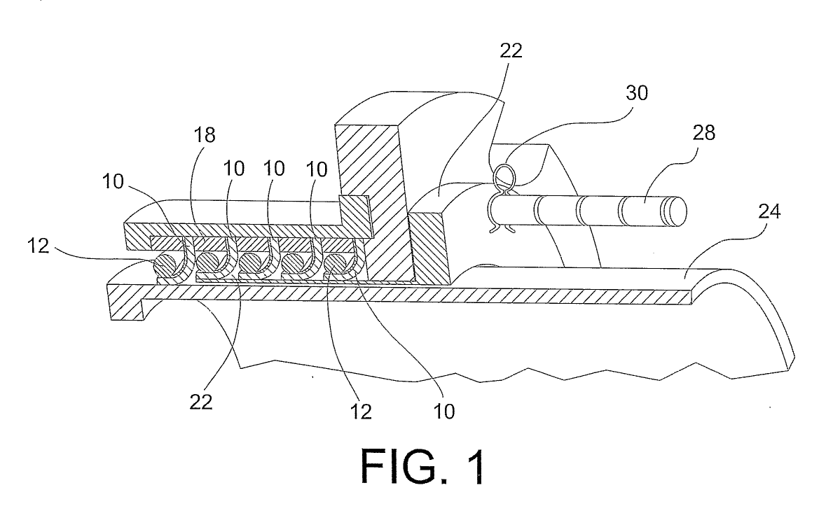

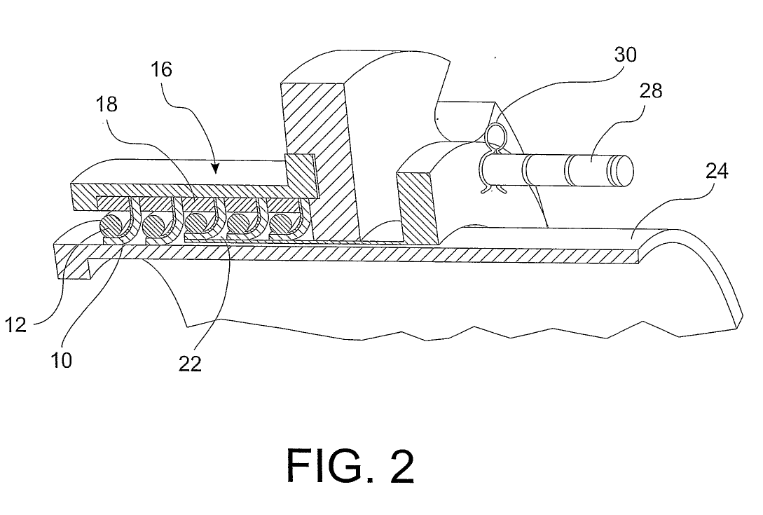

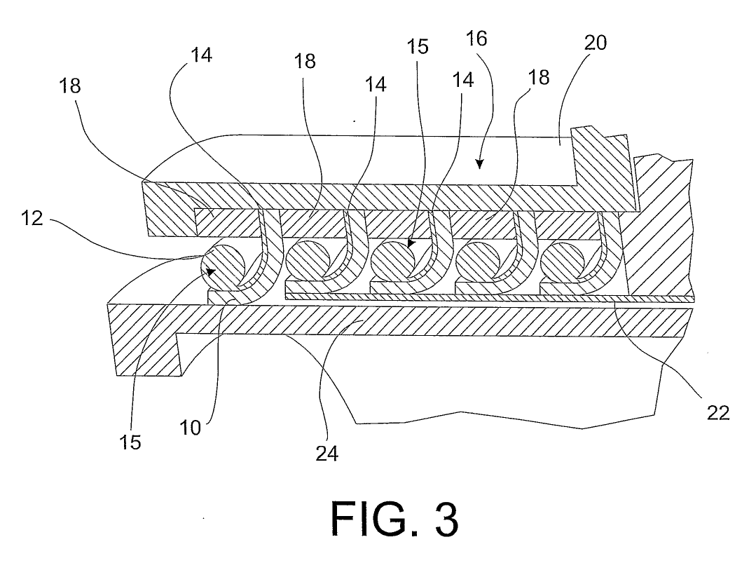

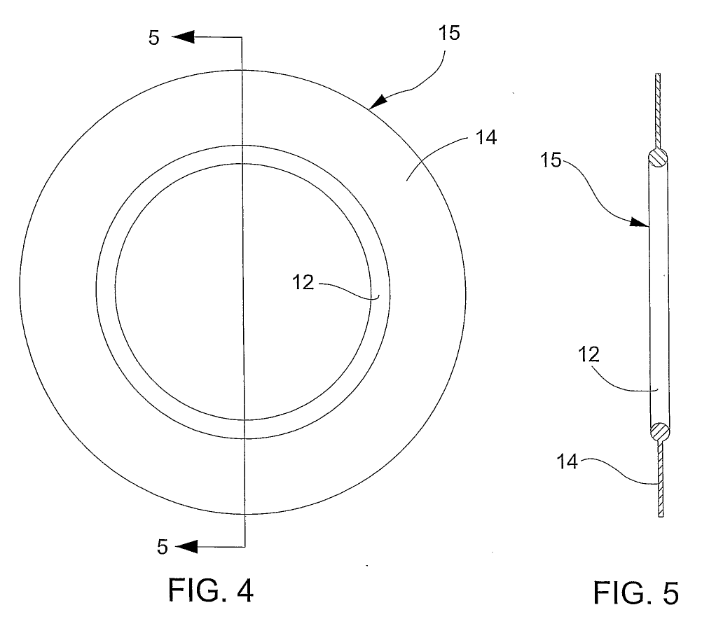

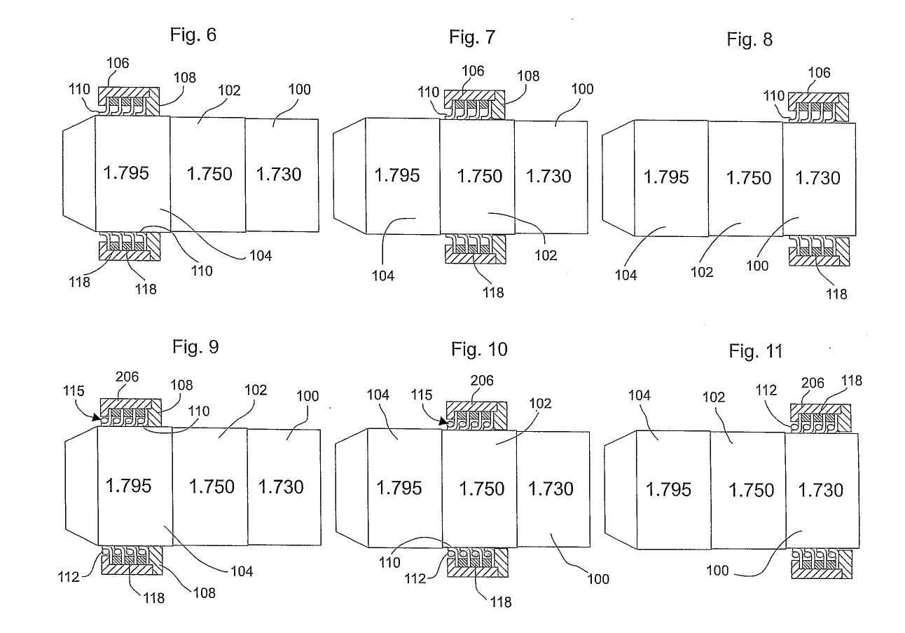

When the lip seal 10 wears to the point of detectable leakage, the barrier member or release sleeve 22 is again actuated until the next-successive lip seal 10 is exposed to the shaft 24, as shown in FIG. 2. The barrier member or release sleeve 22 may be incrementally actuated along guide pins 28 (one of which is visible in FIG. 1). The movement, in predefined increments, of the barrier member or release sleeve 22 may be controlled by clips 30 received in complementary grooves 32 along the length of the guide pins 28. Removal of each successive clip 30 from its respective groove 32 permits sufficient movement of the barrier member or release sleeve 22 along the guide pins 28 to expose the next lip seal 10 to the shaft 24.

Empirical data established through testing supports the increased efficacy of the o-rings 12 in ensuring prompt deployment of the respective lip seals 10. A comparison test was conducted under the following conditions:

### Test 1

Three cylindrical shaft sections of different outside diameters were arranged in a contiguous fashion, largest to smallest. The smallest shaft section 100 had an outside diameter of 1.730 inch. The intermediate shaft section 102 had an outside diameter of 1.750 inch. An outside diameter of 1.750 inch is representative of typical outer diameters of rotating and/or reciprocating shafts 24 about which a sequentially deployable lip seal assembly is employed. The largest shaft section 104 had an outside diameter of 1.795 inch. An outside diameter of 1.795 inch is representative of a typical outer diameter of a barrier member or release sleeve 22 used in combination with shafts 24 and sequentially deployable lip seal assemblies.

As a control, a test housing 106 having an inside diameter of 2.250 inches was loaded with four lip seals 110 made of PTFE, each having an inside diameter (before forming into a loaded condition for deployment) of 1.562 inch, an outside diameter of 2.250 inches, and a cross-section of 0.042 inch. Test spacers 118, each having an outside diameter of 2.250 inches, an inside diameter of 2.070 inches, and a cross-section of 0.090 inch were inserted between each of the lip seals 110. A compression gland 108 was installed at one end of the fourth lip seal 110 to retain the lip seals 110 and test spacers 118 within the test housing 106.

The test housing 106 was applied to a position about the largest shaft section 104, with a diameter of 1.795 inch. The test housing 106 and the cylindrical shaft sections were placed in an ambient temperature of −30° C. for a period of 45 minutes. At the expiration of the 45 minute period, the test housing 106 and the cylindrical shaft sections were removed from the ambient temperature of −30° C., and placed at room temperature of 20° C. The test housing 106 was then moved to a position about the intermediate shaft section 102, with a diameter of 1.750 inch. After moving the test housing 106 to the position about the intermediate shaft section 102, forty-eight minutes elapsed until the four lip seals 110 engaged the outside diameter of the intermediate shaft section 102. Engagement of the lip seals 110 was confirmed by an audible “snap” sound as the respective lip seals 110 made contact with the intermediate shaft section 102, as well as by perceptible resistance to axial forces exerted manually on the cylindrical shaft sections.

The test housing 106 was then moved to a position about the smallest shaft section 100, having an outside diameter of 1.730 inch, which is smaller than the outside diameter of 1.750 inch which is representative of typical outer diameters of rotating and/or reciprocating shafts 24 about which a sequentially deployable lip seal assembly is employed. After moving the test housing 106 to the position about the smallest shaft section 100, three hours elapsed and none of the four lip seals 110 had engaged the outside diameter of the intermediate shaft section 100.

To test the efficacy of energizing devices 115 in ensuring deployment of lip seals 110, another housing 206 having an inside diameter of 2.250 inches was loaded with four lip seals 110 made of PTFE, each having an inside diameter (before forming into a loaded condition for deployment) of 0.562 inch, an outside diameter of 2.250 inches, and a cross-section of 0.042 inch. An energizing device 115, having o-ring 112 with a flange 14 projecting radially outwardly therefrom (not shown in FIGS. 9-11), was placed immediately adjacent each of the lip seals 110. The o-rings 112 each had a cross-section of 0.094 inch. Each of the flanges 14 had a cross-section of 0.016 inch. The energizing devices 115 each had an outside diameter of 2.250 inches, and the inside diameter of each of the o-rings 112 was 1.562 inches.

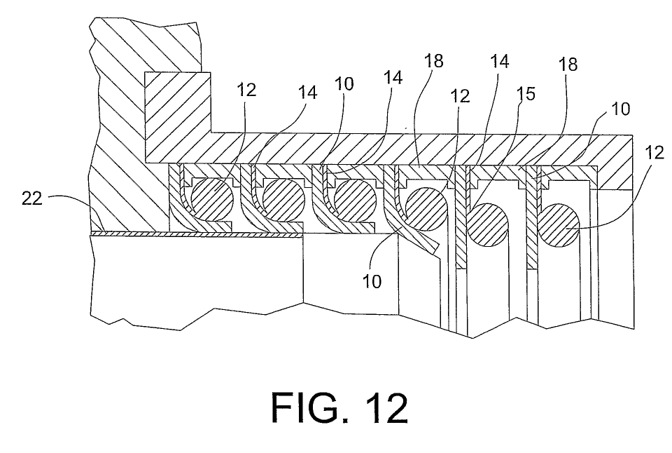

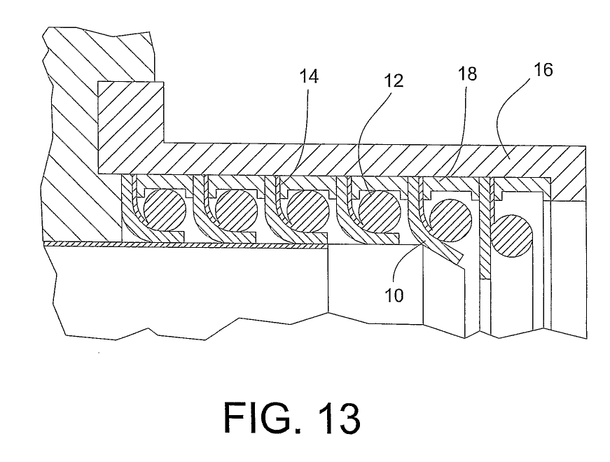

Test spacers 118, each having an outside diameter of 2.250 inches, an inside diameter of 2.070 inches, and a cross-section of 0.090 inch were inserted between adjacent lip seals 110 and energizing devices 115, as shown in FIG. 12. Each of the test spacers 118 was provided with a recess or channel 126 along an interior thereof, which channels 126 were complementary to the curvature of the o-rings 112. A compression gland 108 was installed at one end of the fourth lip seal 110 to retain the lip seals 110, energizing devices 115 and test spacers 118 within the test housing 106.

Just as in the control, the test housing 206, having the energizing devices 115 therein, was applied to a position about the largest-shaft section 104, with a diameter of 1.795 inch. The test housing 206 and the cylindrical shaft sections were placed in an ambient temperature of −30° C. for a period of 45 minutes. At the expiration of the 45 minute period, the test housing 206 and the cylindrical shaft sections were removed from the ambient temperature of −30° C., and placed at room temperature of 20° C. The test housing 206 was then moved to a position about the intermediate shaft section 102, with a diameter of 1.750 inch. After moving the test housing 206 to the position about the intermediate shaft section 102, three minutes elapsed until the four lip seals 110 engaged the outside diameter of the intermediate shaft section 102.

The test housing 206 was then moved to a position about the smallest shaft section 100, having an outside diameter of 1.730 inch. After moving the test housing 206 to the position about the smallest shaft section 100, twenty-five minutes elapsed until the four lip seals 110 engaged the outside diameter of the smallest shaft section 100.

### Test 2

In a second test, the control test housing 106 and the cylindrical shaft sections were placed at room temperature of 20° C. for a period of 12 hours, with the test housing 106 positioned about the largest shaft section 104. The test housing 106 was then moved to a position about the intermediate shaft section 102, and after 50 seconds elapsed, all four lip seals 110 engaged the outside diameter of the intermediate shaft section 102. Next, the test housing 106 was moved to a position about the smallest shaft section 100. Five hours elapsed until all four lip seals 110 engaged the outside diameter of the smallest shaft section 100.

The test housing 206, with the energizing devices 115 therein, was also placed at room temperature of 20° C. for a period of 12 hours, with the test housing 206 positioned about the largest shaft section 104. The test housing 206 was then moved to a position about the intermediate shaft section 102, and after 2 seconds elapsed, all four lip seals 110 engaged the outside diameter of the intermediate shaft section 102. Next, the test housing 206 was moved to a position about the smallest shaft section 100. Two minutes elapsed until all four lip seals 110 engaged the outside diameter of the smallest shaft section 100.

In Test 1 and Test 2, the inside diameter of the largest shaft section 104, simulating a barrier member or release sleeve 22, had a clearance of 0.025 inch greater than the intermediate shaft section 102, simulating a rotating and/or reciprocating shaft. Furthermore, the outside diameter of the intermediate shaft section 102 was 0.020 inch greater than the inside diameter of the largest shaft section 104.

### Test 3

In a third test, the control test housing 106 was placed at room temperature of 20° C. for a period of 1 hour, with the test housing 106 positioned about a shaft section 104 having an outside diameter of 1.795 inch. The shaft 104 was then removed from the test housing 106, and the test housing 106 was held at room temperature for a period of 12 hours. The inside diameter of each of the lip seals 110 at the conclusion of the 12 hour time period was 1.730 inch.

The test housing 206 was also placed at room temperature of 20° C. for a period of 1 hour, with the test housing 206 positioned about a shaft section 104 having an outside diameter of 1.795 inch. The shaft 104 was then removed from the test housing 206, and the test housing 206 was held at room temperature for a period of 12 hours. At the conclusion of the 12 hour period, the inside diameter of each of the lip seals 110, which were provided with the energizing devices 115, was 1.690 inch.

Each of the above tests was performed in the absence of any actual or simulated process fluid and in the absence of any actual or simulated process pressure which, in a real-world application, would assist in deployment of sealing elements like the lip seals 110. Furthermore, the higher the temperature of a fluid to be sealed in a real-world application, the more rapidly the sealing elements will deploy.

In a preferred embodiment, the inner diameter of the o-ring 12 of the energizing device 15 is equal to the outer diameter of the shaft 24 about which the lip seal 10 is to be deployed. For example, both the inner diameter of the o-ring 12 and the outer diameter of the shaft 24 may be 1.750 inch. After deployment, as the lip seal 10 wears down, relatively minimal friction develops between the o-ring 12 and the shaft 24, as compared to if the inner diameter of the o-ring, when in an unstretched condition, was less than the outer diameter of the shaft 24. By providing the inner diameter of the o-ring 12 with an inner diameter equal to the outer diameter of the shaft 24, any interaction of the o-ring 12 and the shaft 24 does not generate heat, even with a lip seal 10 interposed between the o-ring 12 and the shaft 24.

Fluid-Enhanced O-Ring Biasing Members

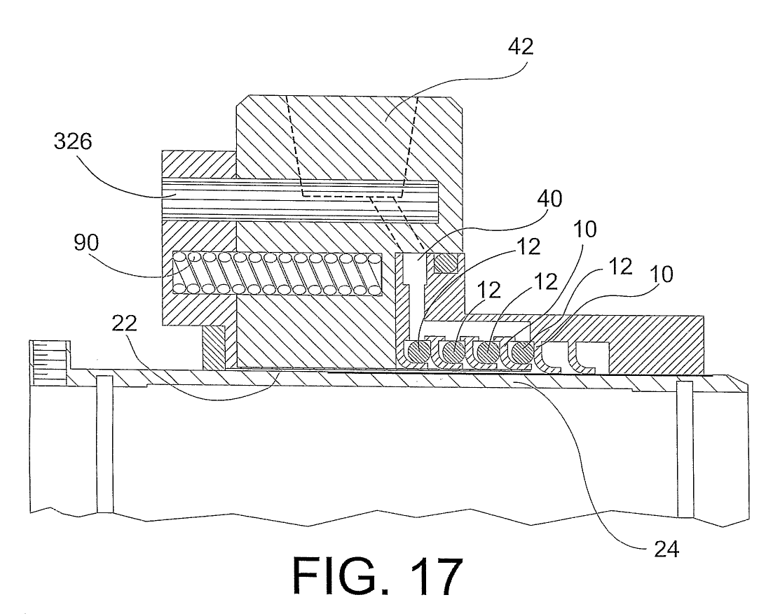

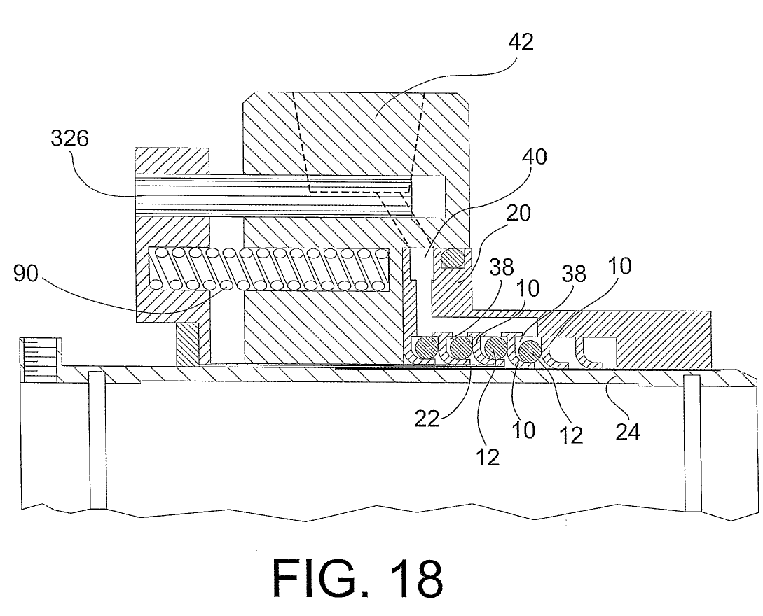

As an alternate to providing the integral mounting flanges 14 which are sandwiched between the cylindrical spacer elements 18 and the membranes that form the lip seals 10, as illustrated in FIGS. 17-20 the biasing member employed as the energizing device 15 may simply take the form of an o-ring 12 without a mounting flange 14. The o-rings 12 are installed between adjacent membranes that form the lip seals 10 prior to insertion of a barrier member or release sleeve 22 through the lip seal assembly. The proximity of the back surface of the lip seal 10 next-downstream to (i.e., in FIG. 17, the lip seal immediately to the right of) the lip seal 10 to be energized by a given biasing member, and the curvature of the front surface of the lip 10 seal to be energized, will hold the o-ring 12 in place. It may be desirable for at least an o-ring associated with first (i.e., most-downstream, at the far right of FIG. 17) lip seal 10 to be provided with a mounting flange (not shown), so as to hold the o-ring 12 associated with that first lip seal 10 in place, or to refrain from employing an o-ring for the most-upstream lip seal 10, because there are no additional lip seals 10 within the lip seal assembly to aid in holding such an o-ring in place.

In order to further enhance the effectiveness of the o-rings 12 in energizing the lip seals 10, once triggered, to move into sealing contact with the shaft 24, a pressurized fluid, such as grease, oil or water, could be provided in an annular cavity 38 between the housing 20 and the o-rings 12. After deployment of the lip seals 10, each of the o-rings 12 preferably maintains contact with the front surface of the associated lip seal 10. This contact provides a seal so the cavity 38 where the fluid is provided can be maintained under pressure, thereby helping to maintain sealed engagement between the lip seal 10 and the shaft 24. The pressure of the fluid may be maintained at all times, whether the lip seals 10 are stored or deployed. The fluid is preferably supplied to the annular cavities 38 by a fluid supply passageway 40 provided in the housing 20. A pressurized reservoir 42 may be provided to supply pressurized fluid to the fluid supply passageway 40.

Apparatus to Reduce Shaft Run Out

A generally cylindrical cartridge 310 includes a first end 312, a second end 314, and a plurality of annular lip seals 316 extending radially inwardly from an inner wall 318 of the cartridge 310. The annular lip seals 316 are axially spaced from one another, such as by a distance x. The spacing between the individual lip seals 316 is preferably, but need not be, uniform. A barrier member or release sleeve 320 having an inner diameter greater than an outer diameter of a shaft 322 about which the lip seals 316 are to be deployed, and an outer diameter greater than an inner diameter of the lip seals 316, is inserted into place from the second end 314 of the cartridge 310 toward the first end 312 of the cartridge 310. The lip seals 316 are thereby loaded against the outer diameter of the release sleeve 320, and the shaft 322 is inserted into the release sleeve 320 (or the release sleeve 320 is loaded about the shaft 322).

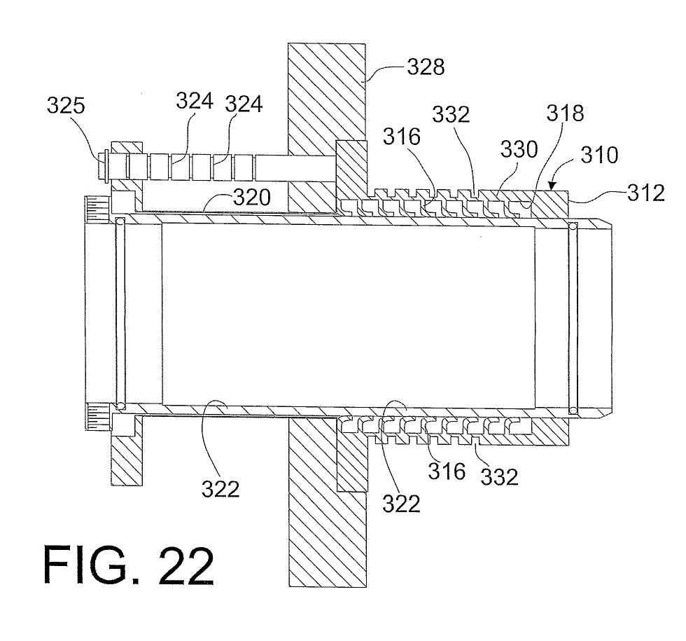

When it is desired to deploy a given lip seal 316 against the shaft 322, the release sleeve 320 is axially advanced (or retracted) relative to the cartridge 310. To facilitate and control the axial movement of the release sleeve 320, a plurality of ring grooves 324 may be arranged along a deployment rod 326 associated with the release sleeve 320, with each of the ring grooves 324 adapted to receive a control ring 325 (see FIG. 22). The control rings 325 facilitate selective progression of the release sleeve 320 along the deployment rod 326, in discrete lengths corresponding to the spacing of the ring grooves 324. Thus, the control rings 325 prevent movement of the deployment rod 326 relative to a gland 328 against which the cartridge 310 is mounted, thereby preventing axial movement of the release sleeve 320 relative to the cartridge 310. The ring grooves 324 are spaced in a manner complementary to the spacing of the lip seals 316, such that upon removal of a control ring 325 from the ring groove 324 closest to the release sleeve 320, movement of the release sleeve to a control ring 325 received in the next ring groove 324 permits release and deployment of the next successive lip seal 316 against the shaft 322. Alternatively, as shown in FIGS. 17-20, or in addition, one or more springs 90 may be provided parallel to (or, while not shown, coaxially with) the deployment rod 326 associated with the release sleeve 320 to actuate or advance the release sleeve 320 so as to deploy the next-successive lip seal 10.

The shaft 322 may rotate and/or reciprocate as part of operation of the machinery (not shown) for which the shaft 322 is employed. Deflection and vibration of the shaft 322 cause shaft run out, which can lead to premature leakage of lip seals 316. To avoid this, and extend the useful life of the cartridge 310, the thickness of the wall 330 of the cartridge 310 is reduced between at least some of the lip seals 316, forming a plurality of annular grooves 332 in the wall 330 of the cartridge 310. The cartridge 310 is preferably made of a flexible, durable material such as PTFE. By reducing the thickness of the wall 330 of the cartridge 310, a bellows effect is achieved. Thus, the wall 330 has a first thickness coincident with the location of the lip seals 316, and a second thickness, which is thinner than the first thickness, in regions between consecutive lip seals 316.

The lip seals 316 are seated in a plurality of segments 334 of the cartridge 310. Each given segment 334, and thereby the lip seal 316 seated therein, is able to essentially ride the run out of the shaft 322. As a result, the lip seal 316 maintains its sealed engagement with the shaft 322 for a longer duration than if the ability of the lip seal 316 to ride the run out of the shaft was prevented by a more rigid cartridge 310.

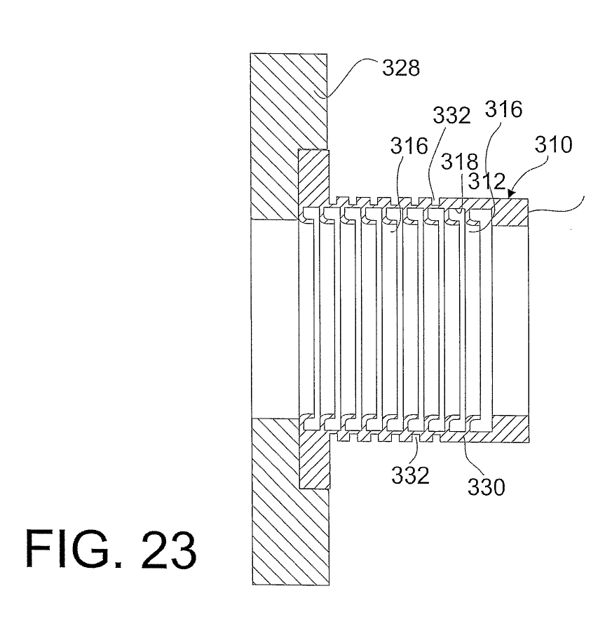

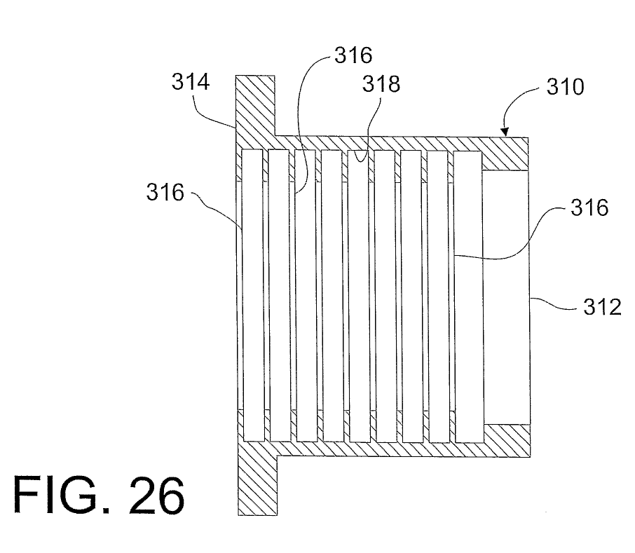

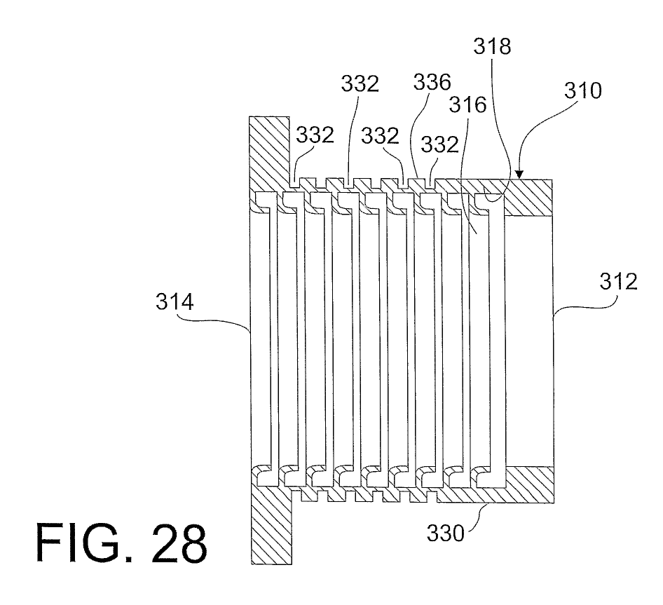

Referring to FIG. 26, the cartridge 310 is first formed as a cylindrical member of Polytetrafluoroethylene (PTFE or Teflon®), or Gylon® available from Garlock, Inc. of Palmyra, N.Y. or other suitable material, with a plurality of annular lip seals 316 extending radially inwardly from an inner surface 318 of the cartridge 310. As indicated in FIG. 23, the annular lip seals 316 are initially flexed, such as by inserting a mandrel (not shown) having an outside diameter greater than the inner diameter of the annular lip seals 316, but less than the diameter at the inner surface 318 of the wall 330, through the central opening of the cartridge 310. Turning now to FIG. 28, the annular grooves 332 are then formed in the cylindrical cartridge 310 by removing material from the wall 330 of the cartridge 310, from an outer surface 336 of the wall 330 toward the inner surface 318 of the wall 330.

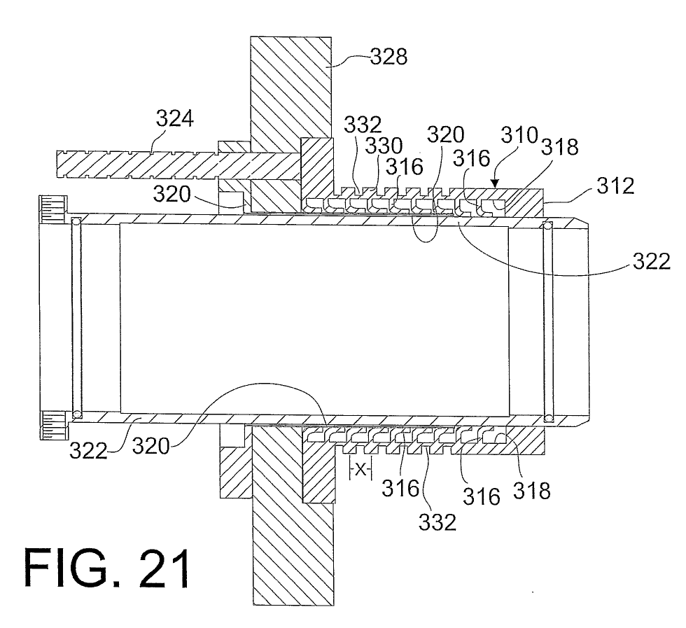

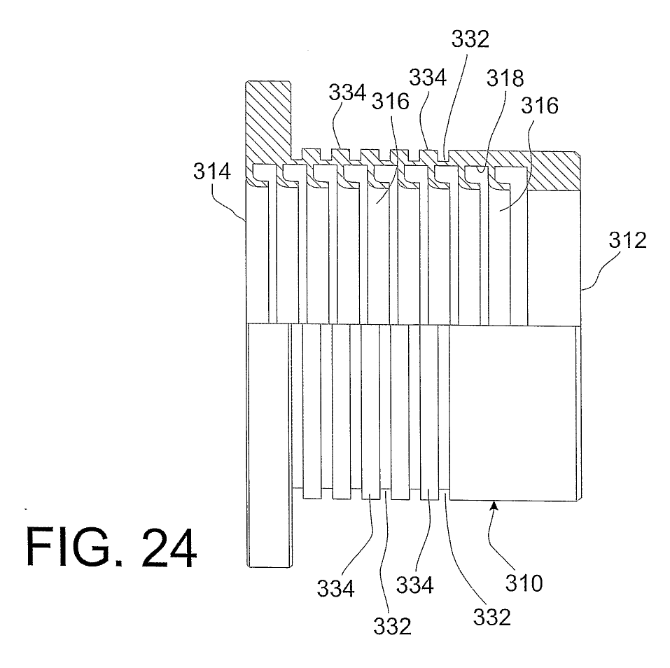

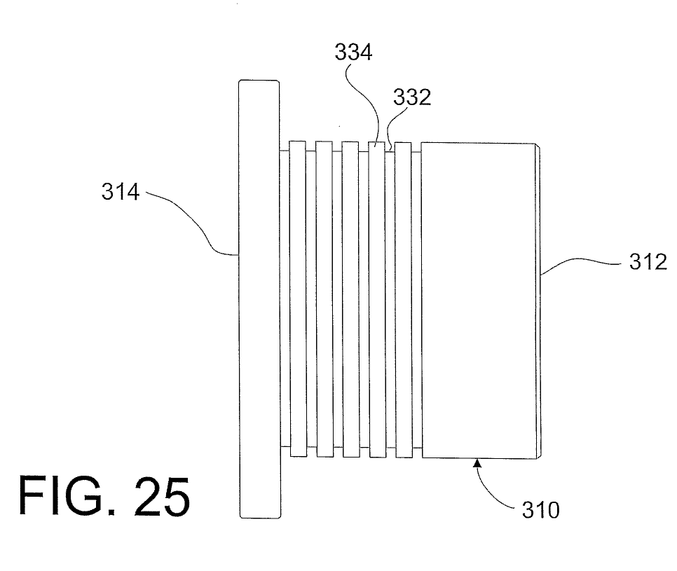

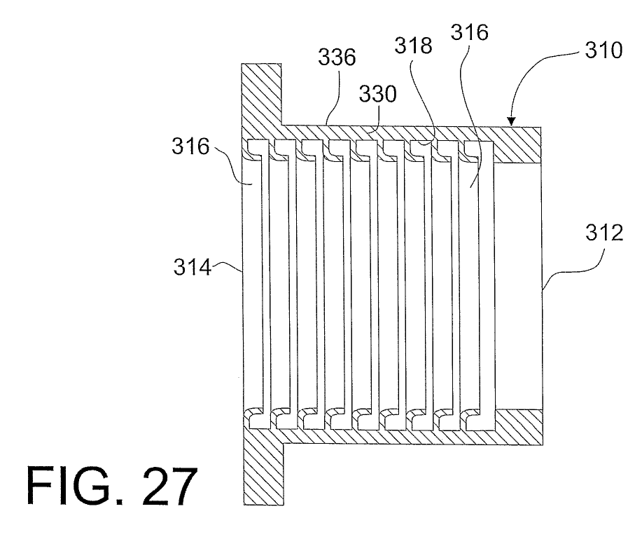

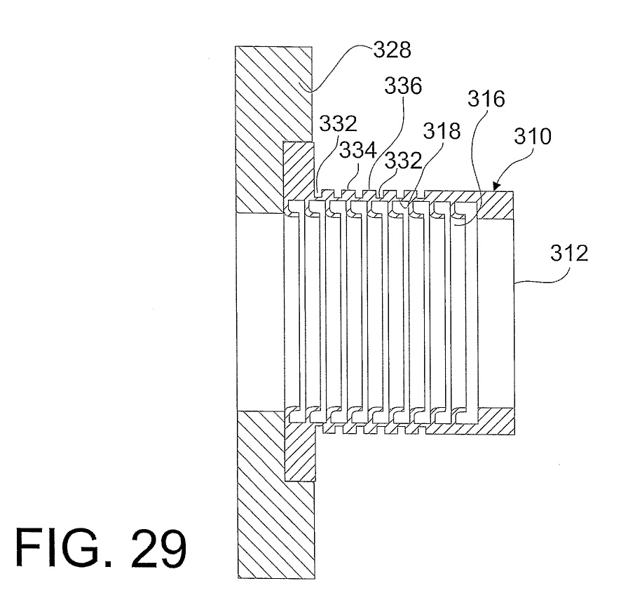

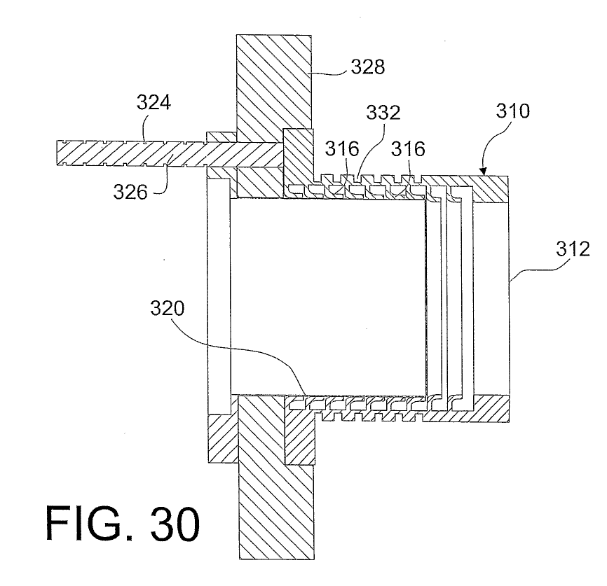

As shown in FIG. 29, the cartridge 310 has annular grooves 332 spaced between segments 334, with a lip seal 316 provided in each segment 334. The annular grooves 332 give the cartridge 310 a bellows-type appearance. The cartridge 310 is installed in a gland 328. Turning to FIG. 26, a release sleeve 320 is then inserted into the cartridge 310, such that the lip seals 316 which are to be selectively deployed are loaded against the outer diameter of the release sleeve 320. The deployment sleeve 320 is provided with a deployment rod 326, which extends through the gland 328, and facilitates incremental movement of the deployment sleeve 320 to selectively deploy the annular lip seals 316. The cartridge 310 of FIGS. 21-30 reduces the need for bushings, vibration dampeners, and other structure to minimize shaft run out, because the TIR before premature leakage of lip seals is increased.

Flush Path

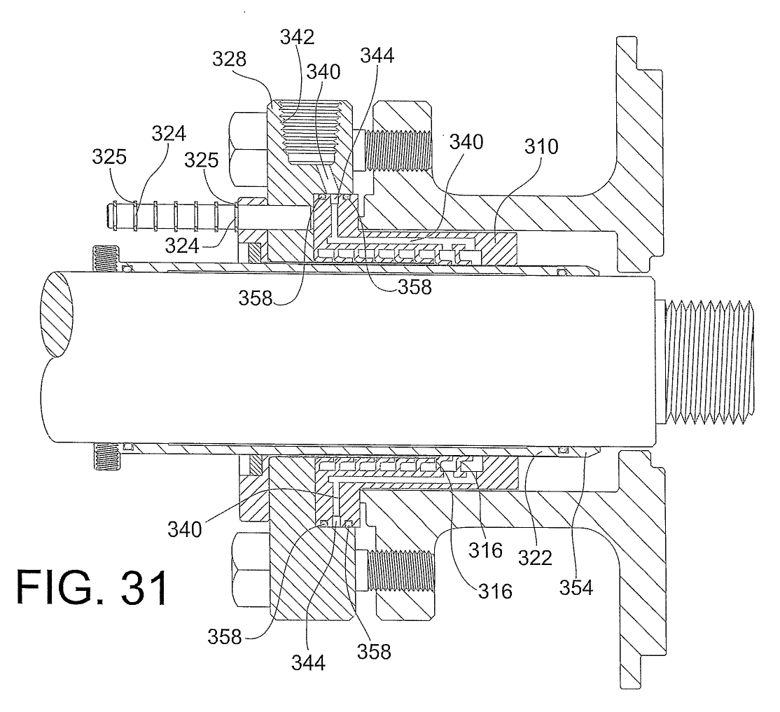

An alternative arrangement for extending the life of a cartridge of sequentially deployable lip seals is shown in FIGS. 31-33. The gland 328 and the cartridge 310 are provided with a bored out flush path 340. The gland 328 has a threaded female port 342 for attachment of a source of fluid, such as water. The fluid to be flushed through the assembly may alternatively be a lubricant, such as grease, coolant, or other desired fluid. Shafts and seals of the nature disclosed are frequently employed in facilities where the assembly is exposed to debris, such as, by way of example only, paper mills where there is constant exposure to fibers, or other refineries or plants where there may be long term exposure to heavy granules, grains, dirt, sand, dust, or other solids or contaminants. By providing an integral flush path 340, such debris may be constantly flushed away from the sealing surface between the shaft 322 and the lip seals 316. The flush fluid may also provide beneficial cooling and lubrication to the sealing surface. The flush fluid may be introduced through the flush path 340 at a high pressure. As a result, it is ensured that whenever the flush fluid is flowing, the lip seals 316 are only exposed to clean flush fluid.

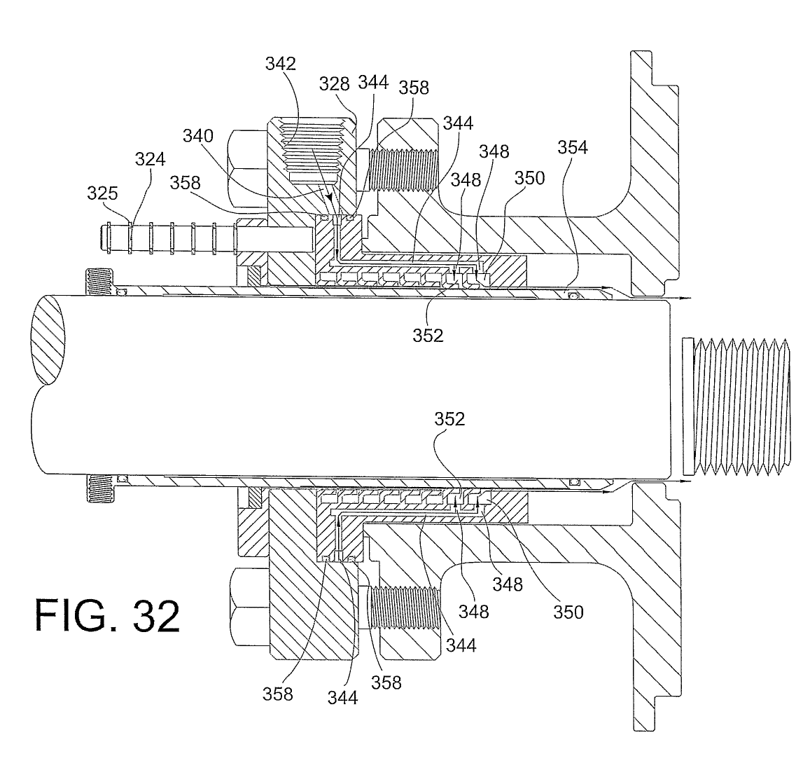

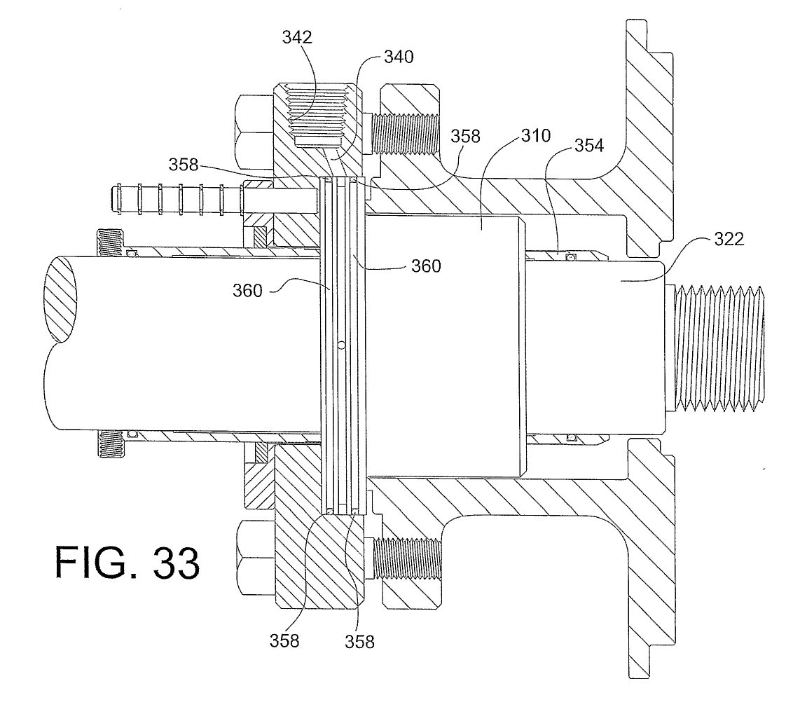

As shown in FIG. 32, the integral flush path 340 includes a single entry port in the gland 328, namely the threaded female port 342. After the flush fluid enters the gland 328, the flush fluid flows into a grooved annulus 344 of the cartridge 310 via a flush feed tube 346 provided in the gland 328. The flush fluid then flows into four holes 348 provided in the cartridge 310. Upon exiting the holes 348, the flush fluid fills first and second annular chambers 350, 352. The flush fluid finally migrates from the annular chambers 350, 352, between a shaft sleeve 354 (which may be provided about the shaft 322) and an alignment register 356, and out into the process. The flow path of the flush fluid is indicated by directional arrows in FIG. 32. A pair of o-rings 358 or sealing gaskets are preferably provided in annular gasket-receiving grooves 360 provided on the cartridge 310, as best seen in FIG. 33.

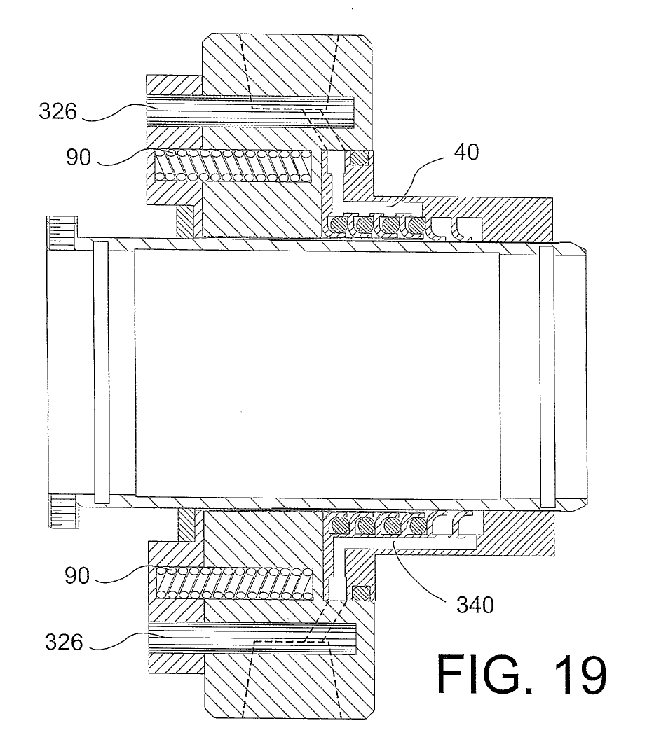

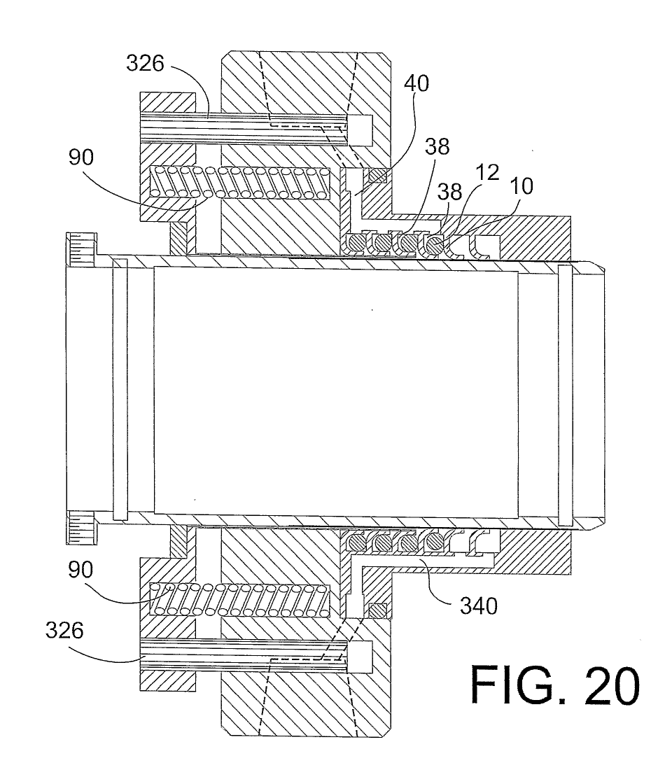

As seen in FIGS. 19 and 20, both the integral flush path 340 and a fluid supply passage 40 may be provided in a single assembly. As such, pressurized fluid may be supplied via the fluid supply passage 40 to annular cavities 38 to help energize the lip seals 10, and flush fluid, pressurized or unpressurized, may be provided to an area immediately adjacent the interface between the deployed lip seals 10 and the shaft 24.

Multi-Part Cartridges

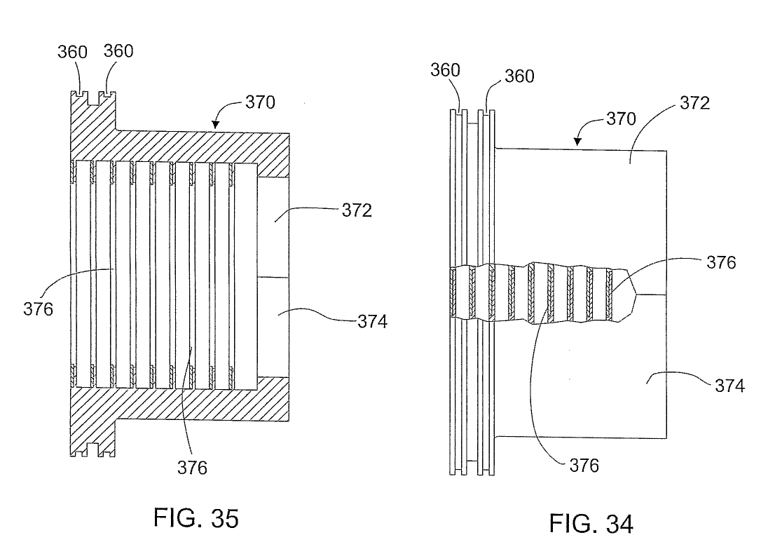

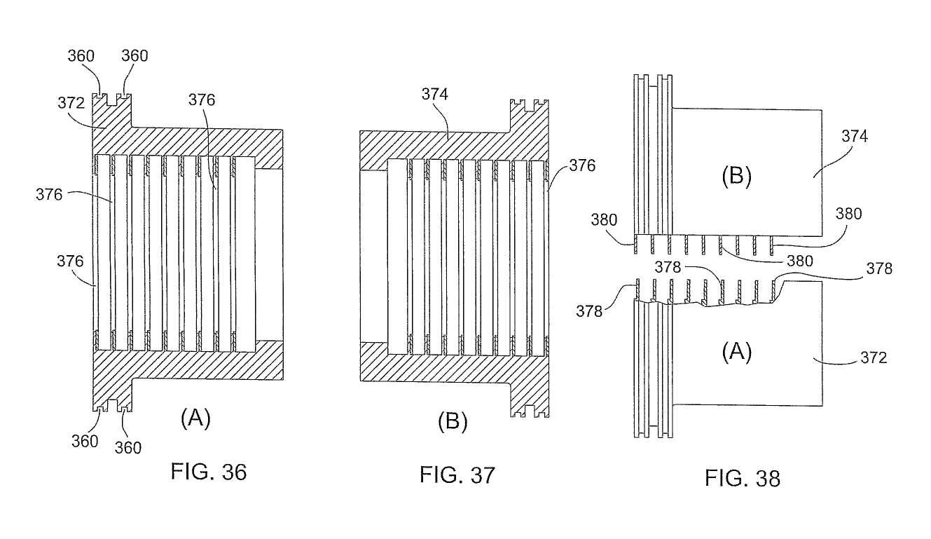

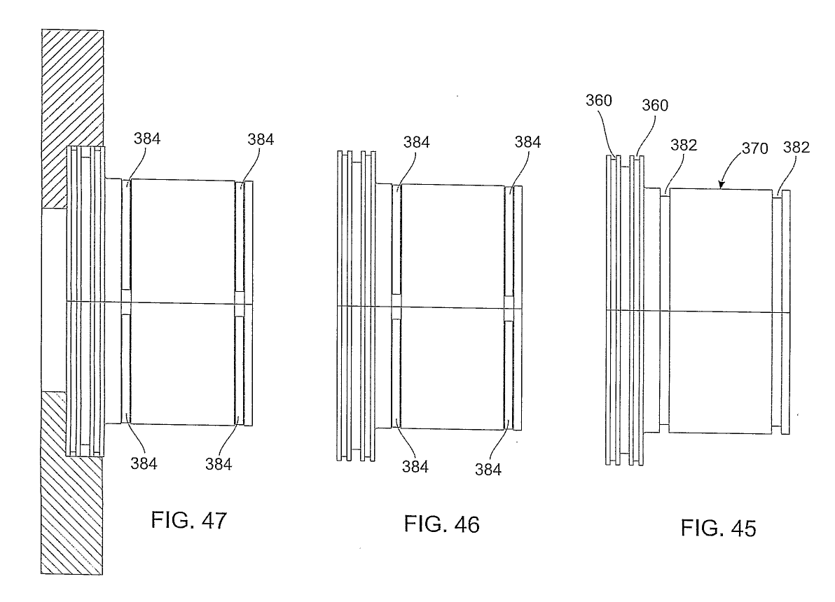

Another improvement to cartridges of sequentially deployable lip seals is shown in FIGS. 34-51. By forming a cartridge 370 in multiple parts, the disassembly of a cartridge for purposes of service, maintenance, or even replacement, is greatly simplified. An exemplary multi-part cartridge 370 has a first part 372 and a separate, complementary second part 374. The cartridge 370 includes a plurality of sequentially deployable annular lip seals 376. Each of the lip seals 376 is formed by overlapping, complementary lip seal portions 378, 380, which are supplied by the respective first and second parts 372, 374. Each of the first and second parts 372, 374 have semi-cylindrical openings, along which the axially-spaced lip seal portions 378 or 380 are disposed. As the first and second parts 372, 374 are brought into contact with one another, the respective complementary lip seal portions 378, 380 engage one another to form each of the lip seals 376. The multi-part cartridge 370 may be supplied with gasket-receiving grooves 360. The multi-part cartridge 370 may be received in a gland 328, as shown in FIG. 47, just as the cartridge 310, discussed above. The manner in which the individual lip seals 376 are sequentially deployed is the same as in the previous embodiments.

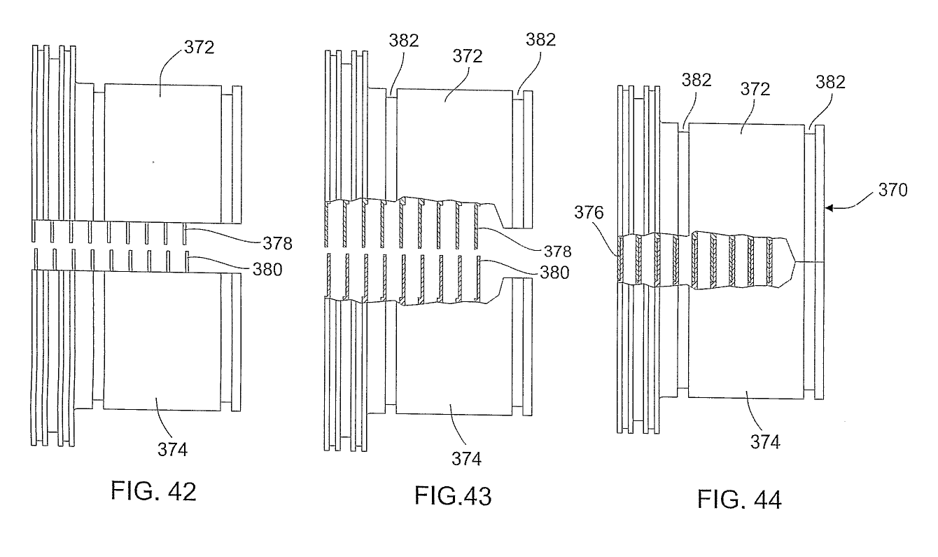

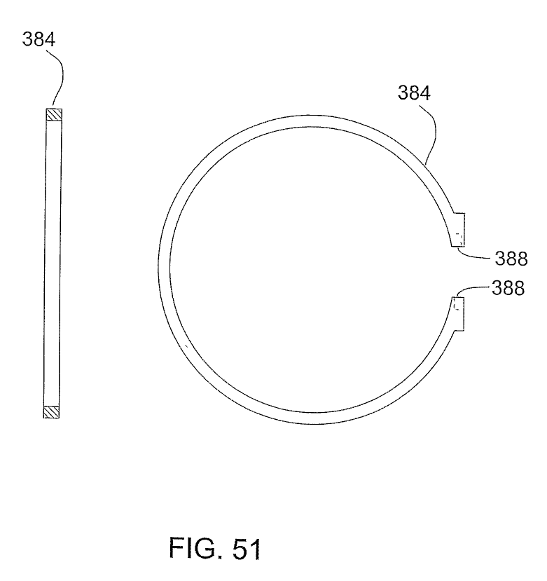

As shown in FIGS. 42-51, the multi-part cartridge 370 may also be provided with clamp-receiving grooves 382 to accommodate clamping rings 384 therein. These clamping rings 384 may serve to secure the first and second parts 372, 374 to one another. The clamping rings 384 may each be in the form of spring retention rings having tool-receiving holes 388 (see FIG. 51) to facilitate insertion of prongs of a tool (not shown) used to spread the ends of a clamping ring 384 apart from one another a sufficient distance to permit installation of the clamping ring 384 into one of the clamp-receiving grooves 382 of the multi-part cartridge 370.

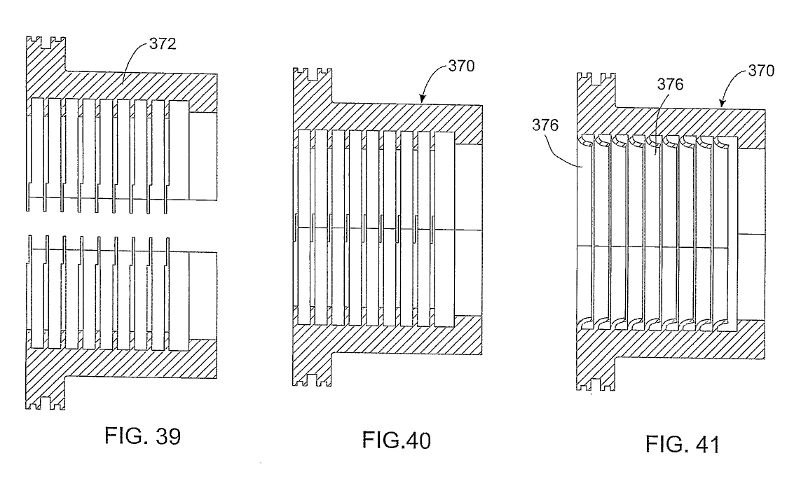

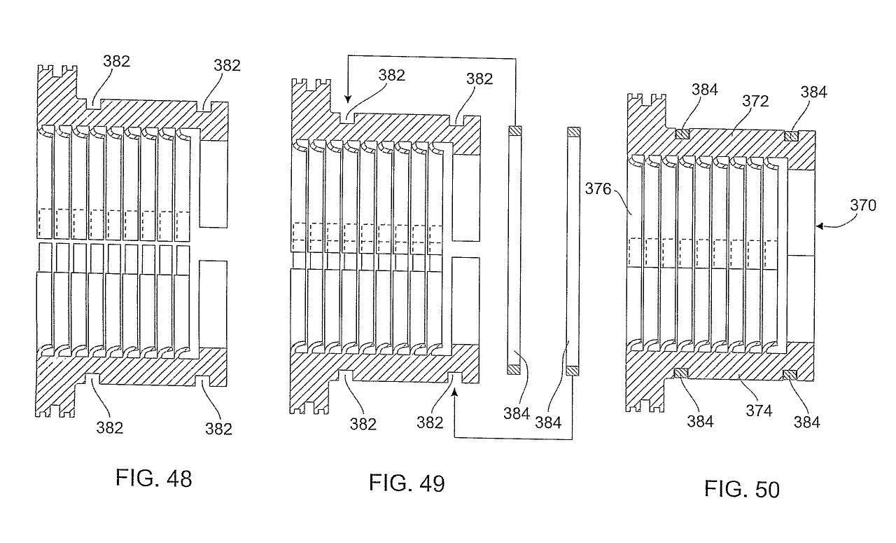

The first and second parts 372, 374 may be engaged with one another while the complementary lip seal portions 378, 380 are in an initial un-flexed condition, as shown in FIGS. 39, 40 and 42-44. Alternately, the first and second parts 372, 374 may be engaged with one another after initial flexing of the complementary lip seal portions 378, 380, as shown in FIGS. 48-49.

While certain embodiments of apparatus to enhance performance of sequentially deployable lip seals have been disclosed, the scope of any appended claims is not limited thereto. Modifications may be made to the apparatus as disclosed herein that are still within the scope of the appended claims.

I claim:

1. A sequentially-deployable lip seal assembly comprising:
a housing;
a plurality of inwardly-directed lip seals arranged along an interior of the housing;
at least one spacer element, one of the at least one spacer elements separating each of the lip seals from an adjacent one of the lip seals; and
at least biasing member contacting a surface of one of the lip seals when the lip seal is in a loaded condition, biasing the lip seal toward a deployed position.

2. The sequentially-deployable lip seal assembly of claim 1, wherein each of the at least one biasing members is an o-ring.

3. The sequentially-deployable lip seal assembly of claim 2, wherein at least one of the o-rings includes a mounting flange projecting radially outwardly therefrom, the mounting flange disposed between one of the spacer elements and one of the lip seals.

4. The sequentially-deployable lip seal assembly of claim 3, wherein at least one of the o-rings is integral with one of the mounting flanges.

5. The sequentially-deployable lip seal assembly of claim 2, wherein at least one of the o-rings has an inner diameter equal to an outer diameter of the shaft.

6. The sequentially-deployable lip seal assembly of claim 2, further comprising fluid provided between at least one of the o-rings and the housing.

7. The sequentially-deployable lip seal assembly of claim 6, wherein the fluid is pressurized.

8. The sequentially-deployable lip seal assembly of claim 6, wherein the housing includes at least one fluid supply passageway to supply the fluid between the at least one o-ring and the housing.

9. The sequentially-deployable lip seal assembly of claim 8, further including a flush path by which a flush fluid may be supplied to an area immediately adjacent an interface between a deployed one of the lip seals and a shaft against which the lip seal is deployed.

10. The sequentially-deployable lip seal assembly of claim 1, further comprising a release sleeve received in the housing and disposed about a shaft against which the lip seals are to be deployed, the release sleeve having an inner diameter greater than the shaft and an outer diameter greater than an inner diameter of each of the lip seals, and wherein each of the biasing members biases the inner diameter of the adjacently-mounted lip seal in a direction toward the release sleeve.

11. The sequentially-deployable lip seal assembly of claim 10, wherein each of the biasing members is an o-ring having an inner diameter less than a combined outer diameter of the release sleeve and twice the thickness of one of the annular lip seals.

12. A sequentially-deployable lip seal assembly, comprising:
a housing and a plurality of axially-spaced, inwardly-directed lip seals arranged along an interior of the housing, the housing having a first thickness coincident with the location of each of the lip seals, and a second thickness, which is thinner than the first thickness, in regions between consecutive lip seals.

13. The sequentially-deployable lip seal assembly of claim 12, wherein the housing is made of a flexible, durable material.

14. The sequentially-deployable lip seal assembly of claim 12, wherein the housing is made of Polytetrafluoroethylene.

15. The sequentially-deployable lip seal assembly of claim 12, wherein the housing includes a flush path by which a flush fluid may be supplied to an area immediately adjacent an interface between a deployed one of the lip seals and a shaft against which the lip seal is deployed.

16. A sequentially-deployable lip seal assembly, comprising:
a housing and a plurality of axially-spaced, inwardly-directed lip seals arranged along an interior of the housing, the housing including a flush path by which a flush fluid may be supplied to an area immediately adjacent an interface between a deployed one of the lip seals and a shaft against which the lip seal is deployed.

17. A sequentially-deployable lip seal assembly, comprising:
a housing having a first part and a separate, complementary second part, each of said first and second parts including a semi-cylindrical opening and a plurality of axially spaced lip seal portions, the lip seal portions of the first part mating with respective lip seal portions of the second part in an overlapping fashion to form a plurality of annular lip seals.

18. The sequentially-deployable lip seal assembly of claim 17, wherein each of the first and second parts includes at least one clamp receiving groove along an exterior thereof, each of the at least one clamp receiving grooves of the first part cooperating with a corresponding clamp receiving groove of the second part to accommodate a clamping ring therein.
